(19) United States
(12) Patent Application Publication
(10) Pub. No.: US 2023/0004824 A1
(43) Pub. Date: Jan. 5, 2023

(54) Method, Apparatus, and Device for Updating Hard Disk Prediction Model, and Medium

(71) Applicant: Inspur Electronic Information Industry Co., Ltd., Jinan (CN)

(72) Inventor: Tinglei Zhang, Jinan (CN)

(21) Appl. No.: 17/781,326

(22) PCT Filed: Jul. 23, 2020
(86) PCT No.: PCT/CN2020/103737

§ 371 Date: May 31, 2022

(30) Foreign Application Priority Data
Dec. 13, 2019 (CN) 201911284442.2

(51) Int. Cl. G06N 5/02

(52) U.S. Cl. CPC G06N 5/022

(57) ABSTRACT

A method, apparatus, and device for updating a hard disk prediction model, and a storage medium. The method comprises: acquiring first sample data used to update a hard disk prediction model, and determining, according to the first sample data, a target decision tree requiring updating in the hard disk prediction model; selecting second sample data from the first sample data according to a preset selection rule; determining, according to the second sample data, a target leaf node requiring updating in the target decision tree; and splitting the target leaf node according to a splitting rule of the hard disk prediction model so as to update the target decision tree. The entire updating process is simple, and a new hard disk prediction model need not be re-established, thereby reducing the time used for updating. Moreover, the accuracy of hard disk fault prediction is improved, and user requirements are better met.

### CROSS REFERENCE TO RELATED APPLICATIONS

The application claims priority to China Patent Application No. 201911284442.2, filed on Dec. 13, 2019 in China National Intellectual Property Administration and entitled “METHOD, APPARATUS, AND DEVICE FOR UPDATING HARD DISK PREDICTION MODEL, AND MEDIUM”, the entire contents of which are incorporated herein by reference.

### TECHNICAL FIELD

The disclosure relates to the technical field of cloud computing data centers, in particular to a method, apparatus, and device for updating a hard disk prediction model, and a medium.

### BACKGROUND

With the rapid development of cloud computing technologies, the total data amount shows an exponential growth. However, in a data center, a hard disk is still a main data storage medium. Once the hard disk fails, a risk of data loss will be produced, bringing serious loss to the enterprise. Therefore, predicting the failures of the hard disk is a very important step to ensure the data storage security.

In general, monitoring data used for representing a status of the hard disk is first acquired from the hard disk; a hard disk failure prediction model is established according to an incremental random forest algorithm and the acquired monitoring data; and the failure situation of the hard disk is predicted through the hard disk failure prediction model. However, the status of the hard disk is constantly changing, and the monitoring data acquired from the hard disk also increases accordingly. Using the same failure prediction model in an incremental scenario will gradually reduce the accuracy of prediction results.

In the prior art, in order to prevent the accuracy of the prediction results from gradually decreasing, a method for re-establishing a hard disk failure prediction model is usually adopted. However, re-establishing the failure model requires re-collection of a large amount of data, and the incremental random forest algorithm is used to perform complex calculations, so that the operation steps are cumbersome and consume time greatly. The method is not suitable for multiple operations in the incremental scenario, and cannot better meet the needs of users.

### SUMMARY

The disclosure aims to provide a method, apparatus, and device for updating a hard disk prediction model, and a medium. Updating of a decision tree in a hard disk prediction model is completed by determining leaf nodes requiring updating in a current hard disk prediction model and only splitting each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; the hard disk failure prediction accuracy is improved, the data storage reliability is ensured, and the needs of users are better met.

In order to solve the above technical problems, the disclosure provides a method for updating a hard disk prediction model, including:

acquiring first sample data to be used to update a hard disk prediction model, and determining, according to the first sample data, a target decision tree requiring updating in the hard disk prediction model;

selecting second sample data from the first sample data according to a preset selection rule;

determining, according to the second sample data, a target leaf node requiring updating in the target decision tree; and

splitting the target leaf node according to a splitting rule of the hard disk prediction model so as to update the target decision tree.

Preferably, the first sample data is specifically SMART data newly added in a hard disk.

Preferably, determining, according to the first sample data, the target decision tree requiring updating in the hard disk prediction model specifically includes:

inputting respective data in the first sample data into respective decision trees of the hard disk prediction model in sequence, and respectively recording prediction results obtained from the respective data in the respective decision trees;

comparing the prediction results with actual results corresponding to the respective data, and calculating prediction accuracies of the respective decision trees; and

determining that a decision tree with a prediction accuracy less than a target accuracy is the target decision tree.

Preferably, the selection rule is specifically as follows: selecting data with prediction results inconsistent with actual results from the first sample data as the second sample data.

Preferably, determining, according to the second sample data, the target leaf node requiring updating in the target decision tree specifically includes:

inputting the second sample data into the target decision tree, and determining whether current decision information obtained by each leaf node in the target decision tree is consistent with stored historical decision information; and

determining that the leaf node is the target leaf node if the current decision information is not consistent with the stored historical decision information.

Preferably, acquiring the first sample data to be used to update the hard disk prediction model specifically includes:

regularly acquiring first sample data to be used to update the hard disk prediction model.

Preferably, the target accuracy is specifically an average of respective prediction accuracies.

In order to solve the above technical problems, the disclosure further provides an apparatus for updating a hard disk prediction model, including:

a first determination module, configured to acquire first sample data to be used to update a hard disk prediction model, and determine, according to the first sample data, a target decision tree requiring updating in the hard disk prediction model;

a selection module, configured to select second sample data from the first sample data according to a preset selection rule;

a second determination module, configured to determine, according to the second sample data, a target leaf node requiring updating in the target decision tree; and

a splitting module, configured to split the target leaf node according to a splitting rule of the hard disk prediction model so as to update the target decision tree.

In order to solve the above technical problems, the disclosure further provides a device for updating a hard disk prediction model, including a memory, configured to store a computer program; and

a processor configured to implement, when executing the computer program, the steps of the above any method for updating the hard disk prediction model.

In order to solve the above technical problems, the disclosure further provides a computer-readable storage medium. The computer-readable storage medium stores a computer program. The computer program, when executed by a processor, implements the steps of the above any method for updating the hard disk prediction model.

According to the method for updating the hard disk prediction model provided by the disclosure, the first sample data to be used to update the hard disk prediction model is first acquired, and the target decision tree requiring updating in the hard disk prediction model is determined according to the first sample data; the second sample data is selected from the first sample data according to the preset selection rule; the target leaf node requiring updating in the target decision tree is determined according to the second sample data; and the target leaf node is split according to the splitting rule of the hard disk prediction model so as to update the target decision tree. Therefore, updating of the decision tree in the hard disk prediction model is completed by determining the leaf nodes requiring updating in a current hard disk prediction model and only updating each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; and the hard disk failure prediction accuracy is improved, the data storage reliability is ensured, and the needs of users are better met.

In addition, the apparatus and device for updating the hard disk prediction model, and the storage medium provided by the disclosure correspond to the above method, and have the same beneficial effects.

### BRIEF DESCRIPTION OF THE DRAWINGS

In order to explain the embodiments of the present disclosure more clearly, the accompanying drawings used in the embodiments will be briefly introduced. Apparently, the accompanying drawings in the following description are only some embodiments of the present disclosure. Those of ordinary skill in the art can obtain other drawings based on these drawings without creative work.

FIG. 1 is a flow chart of a method for updating a hard disk prediction model provided in an embodiment of the disclosure;

FIG. 2 is a structural diagram of an apparatus for updating a hard disk prediction model provided in an embodiment of the disclosure; and

FIG. 3 is a structural diagram of a device for updating a hard disk prediction model provided in an embodiment of the disclosure.

### DETAILED DESCRIPTION

The technical solutions in the embodiments of the disclosure will be clearly and completely described in combination with the accompanying drawings of the embodiments of the disclosure. Apparently, the described embodiments are only part of the embodiments of the disclosure, not all embodiments. Based on the embodiments in the disclosure, all other embodiments obtained by those of ordinary skill in the art without creative work shall fall within the protection scope of the disclosure.

The core of the disclosure is to provide a method, apparatus, and device for updating a hard disk prediction model, and a medium. Updating of a decision tree in a hard disk prediction model is completed by determining leaf nodes requiring updating in a current hard disk prediction model and only updating each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; and the hard disk failure prediction accuracy is improved, the data storage reliability is ensured, and the needs of users are better met.

In order to make those skilled in the art better understand the solutions of the disclosure, the disclosure is further described in detail below with reference to the accompanying drawings and the specific embodiments.

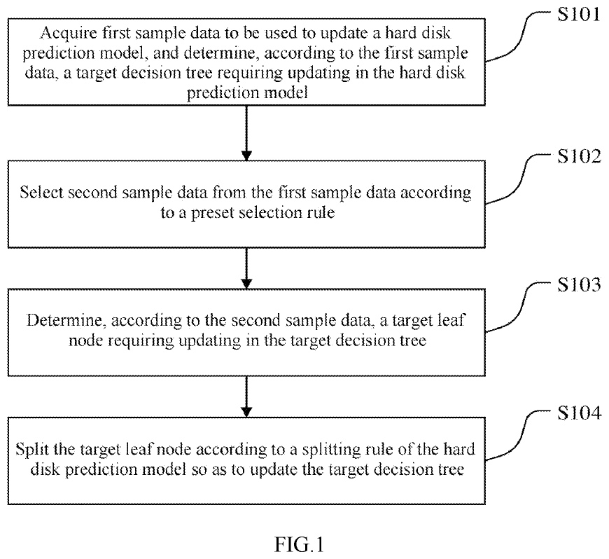

FIG. 1 is a flow chart of a method for updating a hard disk prediction model provided in an embodiment of the disclosure.

As shown in FIG. 1, a method for updating a hard disk prediction model provided in an embodiment of the disclosure includes step S101-step S104.

Step S101: first sample data to be used to update a hard disk prediction model is acquired, and a target decision tree requiring updating in the hard disk prediction model is determined according to the first sample data.

It should be noted that the hard disk prediction model provided by the disclosure is specifically a model built on the basis of a random forest algorithm. During the building of a hard disk failure prediction model, detection data of a hard disk is first acquired, and is then standardized, normalized, and equalized to be preprocessed. The preprocessed detection data is used as a training sample, and training is carried out according to the random forest algorithm to obtain the hard disk failure prediction model. The disclosure provides, according to the hard disk failure prediction model formed by the above method, a method for updating a hard disk prediction model.

In an embodiment, first sample data to be used to update the hard disk prediction model is first acquired. Specifically, the first sample data is specifically SMART data newly added in a hard disk. In the embodiment of the disclosure, the SMART data newly added in a time period from last prediction time to current time is used as the first sample data. Those skilled in the art can also determine, according to an actual application situation, other data to be the first sample data, which is not limited by the embodiment of the disclosure.

In a specific embodiment, the first sample data is input to the hard disk prediction model to determine a target decision tree requiring updating in the hard disk prediction model. In an embodiment, the step that the target decision tree requiring updating in the hard disk prediction model is determined according to the first sample data specifically includes:

inputting respective data in the first sample data into respective decision trees of the hard disk prediction model in sequence, and respectively recording prediction results obtained from the respective data in the respective decision trees;

comparing the prediction results with actual results corresponding to the respective data, and calculating prediction accuracies of the respective decision trees; and

determining that a decision tree with a prediction accuracy less than a target accuracy is the target decision tree.

Specifically, all data contained in the first sample data are input into the respective decision trees of the hard disk prediction model in sequence, and prediction results obtained from the respective data in the respective decision trees are recorded. It can be understood that the prediction results are specifically information used for indicating that the hard disk fails or is normal. Furthermore, when the first sample data is acquired, actual results represented by the respective data are known. For example, actual results corresponding to data in the first ten minutes before the hard disk fails are determined to be failed, and actual results corresponding to other data are determined to be normal. If a hard disk has not had any type of failure yet, it can be determined that the actual results corresponding to all the data contained in the first sample data are normal. The method for acquiring the actual results corresponding to the sample data in detail may refer to the prior art, which is not described in detail here.

The prediction results of the respective data are compared with the actual results to determine an amount of data with the prediction results consistent with the actual results, and the prediction accuracies of the respective decision trees are calculated. The prediction accuracy (Accuracy) can be calculated through the following formula:

$$Accuracy = \frac{TP + TN}{P + N} \times 100 \%$$

where TP represents an amount of data whose actual results are normal and prediction results are normal; TN represents an amount of data whose actual results are failed and prediction results are failed; P represents an amount of data whose actual results are normal among the first sample data; and N represents an amount of data whose actual results are failed among the first sample data. It can be understood that a sum of TP and TN is the amount of data with the prediction results consistent with the actual results, and a sum of P and N is a total amount of the data in the first sample data. For example, the first sample data contains 100 pieces of data, and the hard disk prediction model contains 10 decision trees. After the first sample data passes through the first decision tree in the hard disk prediction model, if the prediction results of 30 pieces of data are consistent with the actual results, the prediction accuracy of the first decision tree is 30%.

According to the above method, the prediction accuracies of the respective decision trees are determined. A decision tree with a prediction accuracy less than a target accuracy is determined to be the target decision tree. In an embodiment, the target accuracy is specifically an average of the prediction accuracies of all the decision trees. Those skilled in the art can also determine, according to an actual application situation, other numerical values to be the target accuracy, which is not limited by the embodiment of the disclosure.

Step S102: second sample data is selected from the first sample data according to a preset selection rule.

In an embodiment, the preset selection rule is specifically as follows: selecting data with prediction results inconsistent with actual results from the first sample data as the second sample data. For example, after 100 pieces of data in the first sample data pass through the target decision tree, if the prediction results obtained from 40 pieces of data are inconsistent with the actual results, the 40 pieces of data are selected as the second sample data.

Step S103: a target leaf node requiring updating in the target decision tree is determined according to the second sampling data.

Step S104: the target leaf node is split according to a splitting rule of the hard disk prediction model so as to update the target decision tree.

In specific implementation, respective data in the second sample data is traversed on the target decision tree, and the target leaf node requiring updating is determined according to current decision information obtained from each leaf node of the target decision tree, which specifically includes:

inputting the second sample data into the target decision tree, and determining whether current decision information obtained by each leaf node in the target decision tree is consistent with stored historical decision information; and

determining that the leaf node is the target leaf node if the current decision information is not consistent with the stored historical decision information.

It should be noted that the current decision information is decision information obtained during current traversing, and the historical decision information is stored decision information obtained by the leaf node last time. When the current decision information of a leaf node is inconsistent with the historical decision information, it can be determined that the leaf node is the target leaf node. The target leaf node is split according to the splitting rule of the hard disk prediction model so as to update the target decision tree. After the updating of all the target decision trees is completed, the updating of the hard disk prediction model is completed. It should be noted that the detail splitting rule of the hard disk prediction model may refer to the prior art, which is not described in detail in the embodiment of the disclosure.

In an embodiment, the first sample data to be used to update the hard disk prediction model can be regularly acquired according to an actual application situation, thus realizing regular updating of the hard disk prediction model.

According to a method for updating a hard disk prediction model provided by the disclosure, first sample data to be used to update a hard disk prediction model is first acquired, and a target decision tree requiring updating in the hard disk prediction model is determined according to the first sample data; second sample data is selected from the first sample data according to a preset selection rule; a target leaf node requiring updating in the target decision tree is determined according to the second sample data; and the target leaf node is split according to a splitting rule of the hard disk prediction model so as to update the target decision tree. Therefore, updating of the decision tree in the hard disk prediction model is completed by determining the leaf nodes requiring updating in the current hard disk prediction model and only updating each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; and the hard disk failure prediction accuracy is improved, the data storage reliability is ensured, and the needs of users are better met.

The disclosure further provides embodiments corresponding to an apparatus for updating a hard disk prediction model and a device for updating a hard disk prediction model. It should be noted that the embodiments are described based on a functional module in one aspect, and hardware in the other aspect.

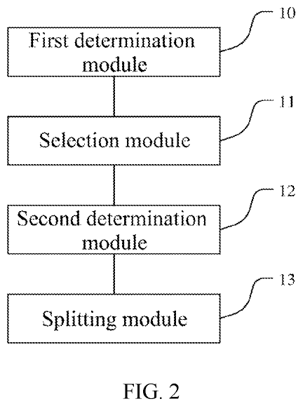

FIG. 2 is a structural diagram of an apparatus for updating a hard disk prediction model provided in an embodiment of the disclosure. As shown in FIG. 2, an apparatus for updating a hard disk prediction model provided in an embodiment of the disclosure includes:

a first determination module 10, configured to acquire first sample data to be used to update a hard disk prediction model, and determine, according to the first sample data, a target decision tree requiring updating in the hard disk prediction model;

a selection module 11, configured to select second sample data from the first sample data according to a preset selection rule;

a second determination module 12, configured to determine, according to the second sample data, a target leaf node requiring updating in the target decision tree; and

a splitting module 13, configured to split the target leaf node according to a splitting rule of the hard disk prediction model so as to update the target decision tree.

The embodiment of this part corresponds to the embodiment of the method part, so that the description of the embodiment of this part refers to the description of the embodiment of the method part, which is not described in detail here.

According to a method for updating a hard disk prediction model provided by the disclosure, first sample data to be used to update hard disk prediction model is first acquired, and a target decision tree requiring updating in the hard disk prediction model is determined according to the first sample data; second sample data is selected from the first sample data according to a preset selection rule; a target leaf node requiring updating in the target decision tree is determined according to the second sample data; and the target leaf node is split according to a splitting rule of the hard disk prediction model so as to update the target decision tree. Therefore, updating of the decision tree in the hard disk prediction model is completed by determining the leaf nodes requiring updating in the current hard disk prediction model and only updating each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; and the hard disk failure prediction accuracy is improved, the data storage reliability is ensured, and the needs of users are better met.

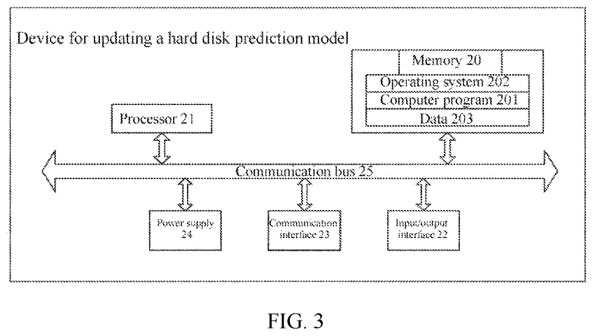

FIG. 3 is a structural diagram of a device for updating a hard disk prediction model provided in an embodiment of the disclosure. As shown in FIG. 3, the disclosure further provides a device for updating a hard disk prediction model, including a memory 20, configured to store a computer program;

a processor 21, configured to implement, when executing the computer program, the steps of the above any method for updating the hard disk prediction model.

The processor 21 may include one or more processing cores, such as a 4-core processor and a 8-core processor. The processor 21 may be implemented in at least one of hardware forms of digital signal processing (DSP), a field programmable gate array (FPGA), or a programmable logic array (PLA). The processor 21 may also include a main processor and a co-processor. The main processor is a processor used to process data in a wake-up state, also referred to as a central processing unit (CPU). The co-processor is a low-power processor used to process data in a standby state. In some embodiments, the processor 21 may be integrated with a graphics processing unit (GPU) that is used to render and draw a content required to be displayed on a display screen. In some embodiments, the processor 21 may further include an artificial intelligence (AI) processor, and the AI processor is used to process computing operations related to machine learning.

The memory 20 may include one or more computer-readable storage media which may be non-transitory. The memory 20 may also include a high-speed random access memory and a non-volatile memory, such as one or more disk storage devices, or flash storage devices. In the embodiment, the memory 20 is at least used to store the following computer program 201. The computer program, after being loaded and executed by the processor 21, implements the relevant steps in the method for updating the hard disk prediction model disclosed in any one of the foregoing embodiments. In addition, resources stored in the memory 20 may also include an operating system 202, data 203, etc., and the storage mode may be short-term storage or permanent storage. The operating system 202 may include Windows, Unix, Linux, and the like.

In some embodiments, the device for updating the hard disk prediction model may further include an input/output interface 22, a communication interface 23, a power supply 24, and a communication bus 25.

Those skilled in the art can understand that the structure shown in FIG. 3 does not constitute a limitation on the device for updating the hard disk prediction model, and may include more or less components than those shown.

The embodiment of this part corresponds to the embodiment of the method part, so that the description of the embodiment of this part refers to the description of the embodiment of the method part, which is not described in detail here. In some embodiments of the disclosure, the processor and the memory may be connected through a bus or in other ways.

The device for updating the hard disk prediction model provided by the disclosure can implement the following method: first acquiring first sample data to be used to update a hard disk prediction model, and determining, according to the first sample data, a target decision tree requiring updating in the hard disk prediction model; selecting second sample data from the first sample data according to a preset selection rule; determining, according to the second sample data, a target leaf node requiring updating in the target decision tree; and splitting the target leaf node according to a splitting rule of the hard disk prediction model so as to update the target decision tree. Therefore, updating of the decision tree in the hard disk prediction model is completed by determining the leaf nodes requiring updating in the current hard disk prediction model and only updating each leaf node, so that updating of the entire hard disk prediction model is completed. The entire updating process is simple; it is not necessary to establish a new hard disk prediction model, and the current hard disk prediction model is adaptively updated only, thus ensuring the timeliness of the hard disk failure prediction model and saving the time for updating at the same time; and the hard disk failure prediction accuracy is improved, the data storage reliability is ensured, and the needs of users are better met.

Finally, the disclosure further provides an embodiment corresponding to a computer-readable storage medium. A computer program is stored on the computer-readable storage medium. The computer program, when executed by a processor, implements the steps in the above method embodiment.

It can be understood that if the method in the above embodiment is implemented in the form of a software functional unit and sold or used as a standalone product, the method may be stored in a computer-readable storage medium. Based on this understanding, the technical solutions of the disclosure essentially or a part that contributes to the prior art or all or part of the technical solutions can be embodied in the form of a software product, and the computer software product is stored in one storage medium to perform all or part of the steps of the method described in the various embodiments of the disclosure. The aforementioned storage media include: a USB flash disk, a mobile hard disk, a read-only memory (ROM), a random access memory (RAM), a magnetic disk or an optical disk, and other media that can store program codes.

The above are the detailed descriptions of the method, apparatus and device for updating the hard disk prediction model, and the medium. All the embodiments in the specification are described in a progressive manner, each embodiment focuses on the difference from other embodiments, and same or similar parts between all the embodiments refer to each other. Since the apparatus disclosed in the embodiments corresponds to the method disclosed in the embodiments, the description is relatively simple, and the relevant part can refer to the description of the method part. It should be pointed out that those of ordinary skill in the art can also make several improvements and modifications to the disclosure without departing from the principle of the disclosure, and these improvements and modifications also fall within the protection scope of the claims of the disclosure.

It should be noted that in this specification, relational terms such as first and second are used merely to distinguish one entity or operation from another entity or operation, instead of necessarily requiring or implying that these entities or operations have any of these actual relationships or orders. Furthermore, terms “include”, “comprise” or any other variants thereof are intended to cover non-exclusive inclusions, so that a process, method, object or device that includes a series of elements not only includes these elements, but also includes other elements which are not definitely listed, or further includes elements inherent to this process, method, object or device. Without more restrictions, elements defined by a sentence “includes a/an . . . ” do not exclude that the process, method, object or device that includes the elements still includes other identical elements.

1. A method for updating a hard disk prediction model, comprising:
acquiring first sample data to be used to update a hard disk prediction model, and determining, according to the first sample data, a target decision tree requiring updating in the hard disk prediction model;
selecting second sample data from the first sample data according to a preset selection rule;
determining, according to the second sample data, a target leaf node requiring updating in the target decision tree; and
splitting the target leaf node according to a splitting rule of the hard disk prediction model so as to update the target decision tree.

2. The method for updating the hard disk prediction model according to claim 1, wherein the first sample data is specifically SMART data newly added in a hard disk.

3. The method for updating the hard disk prediction model according to claim 1, wherein determining, according to the first sample data, the target decision tree requiring updating in the hard disk prediction model specifically comprises:
inputting respective data in the first sample data into respective decision trees of the hard disk prediction model in sequence, and respectively recording prediction results obtained from the respective data in the respective decision trees;
comparing the prediction results with actual results corresponding to the respective data, and calculating prediction accuracies of the respective decision trees; and
determining that a decision tree with a prediction accuracy less than a target accuracy is the target decision tree.

4. The method for updating the hard disk prediction model according to claim 3, wherein the selection rule is specifically as follows: selecting data with prediction results inconsistent the actual results from the first sample data as the second sample data.

5. The method for updating the hard disk prediction model according to claim 1, wherein determining, according to the second sample data, the target leaf node requiring updating in the target decision tree specifically comprises:
inputting the second sample data into the target decision tree, and determining whether current decision information obtained by each leaf node in the target decision tree is consistent with stored historical decision information; and
determining that the leaf node is the target leaf node under the condition that the current decision information is not consistent with the stored historical decision information.

6. The method for updating the hard disk prediction model according to claim 1, wherein acquiring the first sample data to be used to update the hard disk prediction model specifically comprises:
regularly acquiring first sample data to be used to update the hard disk prediction model.

7. The method for updating the hard disk prediction model according to claim 3, wherein the target accuracy is specifically an average of respective prediction accuracies.

8. (canceled)

9. A device for updating a hard disk prediction model, comprising a memory, configured to store a computer program;
a processor, configured to implement, when executing the computer program, steps of the method for updating the hard disk prediction model according to claim 1.

10. A computer-readable storage medium, wherein the computer-readable storage medium stores a computer program; and the computer program, when executed by a processor, implements the steps of the method for updating the hard disk prediction model according to claim 1.
